(19) United States
(12) Patent Application Publication
(10) Pub. No.: US 2009/0196818 A1
(43) Pub. Date: Aug. 6, 2009

(54) MULTIFERROIC ELEMENT

(75) Inventors: Yoshinori Tokura, Ibaraki (JP); Takahisa Arima, Miyagi (JP); Yoshio Kaneko, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JAPAN SCIENCE AND TECHNOLOGYAGENCY, KAWAGUCHI-SHI (JP)

(21) Appl. No.: 12/299,778

(22) PCT Filed: Apr. 12, 2007
(86) PCT No.: PCT/JP2007/058027

§ 371 Date: Nov. 6, 2008

(30) Foreign Application Priority Data
May 24, 2006 (JP) 2006-144309

(51) Int. Cl. C01G 37/02; C01G 49/00; C01G 53/00; C01G 51/00

(52) U.S. Cl. 423/594.1; 423/594.3; 423/594.5

(57) ABSTRACT

A multiferroic element having a simple structure in which orientation of electric polarization or magnetization of a solid state material can be controlled by applying a magnetic field or an electric field, respectively. By applying an external magnetic field to a multiferroic solid state material that exhibits ferroelectricity and ferromagnetism having a spin structure such that the orientation of spin is rotating along the outside surface of a cone (apex angle α at the top of the cone is in a range of 0<α≦90 degrees), an electric polarization with orientation substantially perpendicular to the direction of the externally applied magnetic field can be controlled. Meanwhile, by applying an external electric field to the multiferroic solid state material, a magnetization with an orientation substantially perpendicular to the direction of the externally applied electric field can be controlled.

### TECHNICAL FIELD

The present invention relates to a multiferroic element.

### BACKGROUND ART

The present invention relates to a multiferroic element having both ferroelectricity and ferromagnetism, and is particularly used as a magnetic sensor which is suitable to read out information stored by means of magnetization. Furthermore, the multiferroic element can be applied as a memory element.

Conventionally, an orientation of an electric polarization in a solid state material was not able to be reversed by a magnetic field. Conversely, an orientation of a magnetization in a solid state material was not able to be reversed by an electric field, either. If these functions are made possible in a solid state material, various technological developments will be possible by using these effects. The present invention relates to a multiferroic element having new functions not present conventionally. This multiferroic element can be applied as a magnetic sensor element. By making use of the function of the multiferroic element, it becomes possible to read out information buried in the orientation of magnetization without using a complicated apparatus, such as an apparatus including a magnetic sensor using the magneto-optical effect and a large pick-up coil. As an inverse effect, since an orientation of magnetization in a solid state material can be controlled by applying an electric field, the multiferroic element can be applied as a memory element. The MRAM element, which is the frontier memory element many manufacturers are now competing in development for, can be replaced by this multiferroic element. Since this multiferroic element is an element controlled by an electric field, a large power consumption, which is an issue of the MRAM element now under development, can be reduced by this multiferroic element [Refer to Non Patent Document 1].

### [Non Patent Document 1] Tsuneyuki MIYAKE; NIKKEI MICRO DEVICE, p. 72, (2003).

[Non Patent Document 2] K. TOMIYASU et. al., Phys. Rev. B 70, 214434, (2004).

### DISCLOSURE OF INVENTION

By taking the situation described above into account, the purpose of the present invention is to provide a multiferroic element having a simple structure in which an orientation of an electric polarization or a magnetization of a solid state material can be controlled by applying a magnetic field or an electric field, respectively.

To achieve the purpose described above, the present invention provides a multiferroic element comprising a multiferroic solid state material having both ferroelectricity and ferromagnetism which has a spin structure in which the orientation of spin is rotating along the outside surface of a cone (apex angle α at the top of the cone is in a range of 0<α≦90 degrees) wherein by applying an external magnetic field to the multiferroic solid state material, an orientation of an electric polarization which is substantially perpendicular to the direction of said externally applied magnetic field can be controlled, as described in claim 1.

Alternatively, the present invention provides a multiferroic element comprising a multiferroic solid state material having both ferroelectricity and ferromagnetism which has a spin structure in which the orientation of spin is rotating along the outside surface of a cone (apex angle α at the top of the cone is in a range of 0<α≦90 degrees) wherein by applying an external electric field to the multiferoic solid state material, an orientation of a magnetization which is substantially perpendicular to the direction of said externally applied electric field can be controlled, as described in claim 2.

The multiferroic solid state material according to claim 1 or 2 described above may be a multiferroic element comprising a chromium oxide including MCr₂O₄ (M=Mn, Fe, Co, Ni) compound, as described in claim 3.

The MCr₂O₄ (M=Mn, Fe, Co, Ni) compound according to claim 3 may be a multiferroic element which is a single crystal produced under an environment of high gas pressure of a range from more than or equal to 2 atmosphere to less than 11 atmosphere by using the floating zone single crystal growth method, as described in claim 4.

### BRIEF DESCRIPTION OF THE DRAWINGS

FIG. 1 is a schematic diagram illustrating a basic structure of a multiferroic magnetic sensor element according to the present invention.

FIG. 2 is a schematic diagram illustrating a basic structure of a multiferroic memory element according to the present invention.

FIG. 3 shows an experimental arrangement to confirm a function of a multiferroic magnetic sensor according to the present invention.

FIG. 4 shows a photograph in place of a drawing illustrating a crystal of a multiferroic solid state material CoCr₂O₄ according to the present invention.

FIG. 5 is a diagram illustrating a temperature dependence of magnetization of a multiferroic solid state material CoCr₂O₄ according to the present invention.

FIG. 6 is a diagram illustrating a spin structure of a multiferroic solid state material CoCr₂O₄ in accordance with the present invention.

FIG. 7 is a diagram illustrating a temperature dependence of electric polarization of a multiferroic solid state material CoCr₂O₄ according to the present invention.

FIG. 8 is a diagram illustrating a reversal of electric polarization resulting from a reversal of external magnetic field of a multiferroic solid state material CoCr₂O₄ according to the present invention.

### BEST MODE FOR CARRYING OUT THE INVENTION

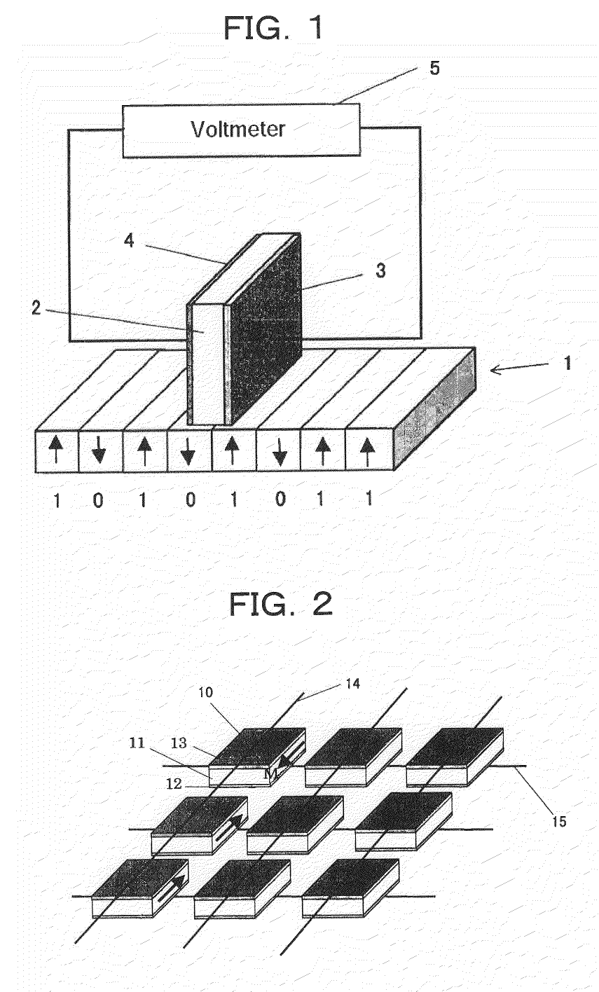

A structure of a multiferroic magnetic sensor element as shown in FIG. 1 may have a structure comprising a multiferroic solid state material sandwiched by two metallic electrodes using a voltmeter to detect an electric polarization being generated by a magnetic field leaked from the magnetization corresponding to information and being oriented substantially perpendicular to said magnetic field.

Furthermore, a multiferroic memory element comprises a multiferroic solid state material sandwiched between two metallic electrodes as shown in FIG. 2. By applying a voltage between a specifically selected bit line and a word line, a magnetization generates in the specified orientation in the single memory element sandwiched between the selected lines. The generated magnetization has a memory function. The space between the memory elements is of a buried structure filled by a non-magnetic solid state material.

Embodiments of the present invention will be described in the following.

FIG. 1 is a schematic diagram illustrating a basic structure of a multiferroic magnetic sensor element in accordance with the present invention.

In this Figure, reference numeral 1 represents a vertical magnetic recording material (vertical magnetic recording film), 2 represents a multiferroic solid state material, 3 and 4 represent electrodes configured to sandwich the multiferroic solid state material 2, and 5 represents a voltmeter connected to the electrodes 3 and 4 to measure electric charge generated on the surface of the electrodes 3 and 4 of the multiferroic solid state material 2, the electric charge being generated by the induced electric polarization.

This magnetic sensor element comprises a solid state material which functions not only as a magnetic sensing part but also a generation part of an electric polarization, and therefore can be configured simply without using a peculiar shape.

This configuration enables to make a structure of the magnetic sensor element simple, and realizes a significant cost reduction. Furthermore, since the magnetic sensor element can be miniaturized, it can be a magnetic sensor which can keep in step with to the miniaturization of the magnetization region performing to store information. Meanwhile, it can be a memory element by using a function to reverse magnetization by applying an electric field.

FIG. 2 is a schematic diagram illustrating a basic structure of a multiferroic memory element in accordance with the present invention.

In this Figure, 11 represents a multiferroic solid state material, 12 and 13 represent electrodes to sandwich the multiferroic solid state material 11. This unit forms a minimum unit of the memory cell 10. By simply arranging this minimum unit memory cell 10 in a two dimensional plane, a memory element is constructed. Writing operation is performed by selecting a specified bit line 14 and a specified word line 15 and by applying a positive voltage between them. The induced magnetization M is generated in a forward orientation. If a negative voltage is applied to the next memory element, the induced magnetization M is generated in a backward orientation and information is stored. To read out it is sufficient to measure the sign of the electric charge (voltage) of the selected memory element. The structure of the memory element as described above is extremely simple. In addition, generated read out signal has both positive and negative polarity.

The MRAM element now under development has a memory control system making use of a magnetic field induced by a current. The multiferroic memory element described above, on the other hand, uses magnetization reversal induced by an electric field. The electric field induced effect, unlike the current induced magnetic field, can reduce significantly a current consumption. Therefore, the multiferroic memory element can avoid a large power consumption which is a drawback of the conventional MRAM element, thereby enabling reduction in power consumption. Furthermore, since the read out signal is positive and negative signal, it is immune to noise as compared with the MRAM element where signal discrimination is based on the magnitude of resistance. The MFM element becomes a non-volatile memory element, same as the MRAM element.

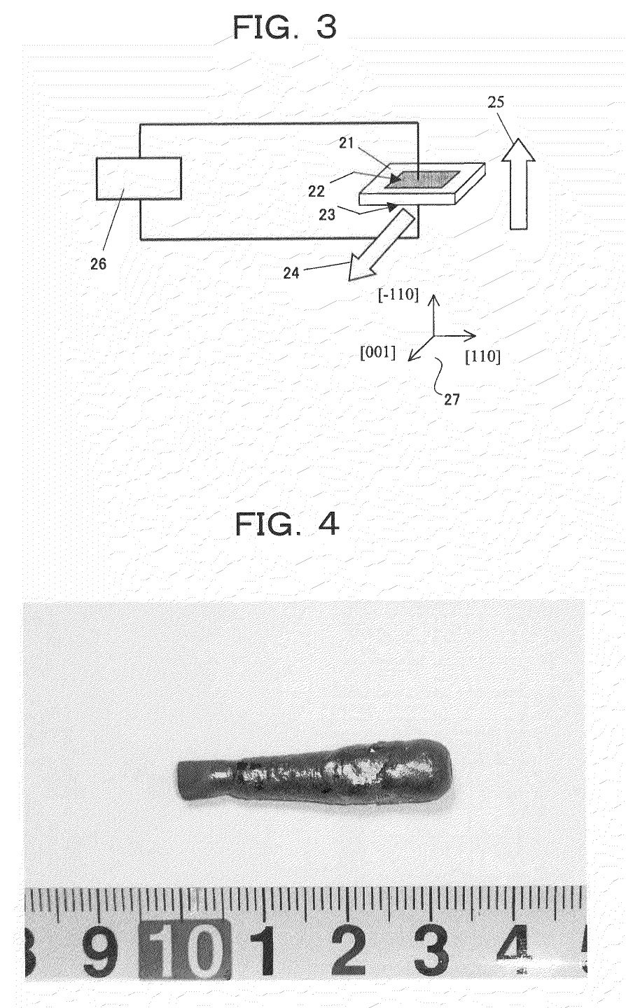

FIG. 3 shows an experimental arrangement to confirm a function of a multiferroic magnetic sensor in accordance with the present invention.

In this Figure, 21 represents a multiferroic solid state material, 22 and 23 represent an upper and a lower electrodes to sandwich the multiferroic solid state material 21, 24 represents an external magnetic field applied to the multiferroic solid state material 21, 25 represents an orientation (almost perpendicular to the external magnetic field) of the electric polarization induced in the multiferroic solid state material 21, and 26 represents a voltmeter to measure electric charge induced on the surface of the upper and lower electrodes of the multiferroic solid state material 21, the electric charge being generated due to the induced electric polarization. 27 shows an arrangement of the crystal orientation of the multiferroic solid state material 21, the detail of which will be described later.

Here, silver paste was used as electrodes 22, and 23, however, other material such as metal including aluminum and gold may be used.

As a multiferroic solid state material 21, CoCr₂O₄ was selected among chromium oxide group with same spin arrangement. 27 is an arrangement of the crystal orientation in this case. A single crystal of this material was grown under an environment of high gaseous pressure of a range from more than or equal to 2 atmosphere to less than 11 atmosphere by using the floating zone single crystal growth method. Such a single crystal was conventionally obtained only by the flux method. With this conventional flux method, a size of the single crystal was at most 1-2 mm, not enough for the present experimental arrangement. Then, the floating zone single crystal growth method was applied here, which had possibility to grow crystal of more than several mm. Under an environment of high gas pressure of a range from more than or equal to 2 atmosphere to less than 11 atmosphere it was achieved to grow a large size single crystal.

FIG. 4 shows a photograph in place of a drawing illustrating a crystal of a multiferroic solid state material CoCr₂O₄ in accordance with the present invention.

First, CoO and Cr₂O₃ are mixed stoichiometrically to be a starting material and subjected to a solid state reaction at 1200° C. for 12 hours. Then it formed into a rod by hot pressing, and sintered in an argon gas at 1300° C. for 12 hours. In the floating zone single crystal growth method, a lamp heating method in a confocal ellipsoid is used. The lamp was a xenon lamp. To suppress evaporation, an environment was argon gas under 10 atmosphere. The growth speed for the single crystal was 40 mm/hour. Then, [100] surface which is as large as 2×2 mm² was obtained.

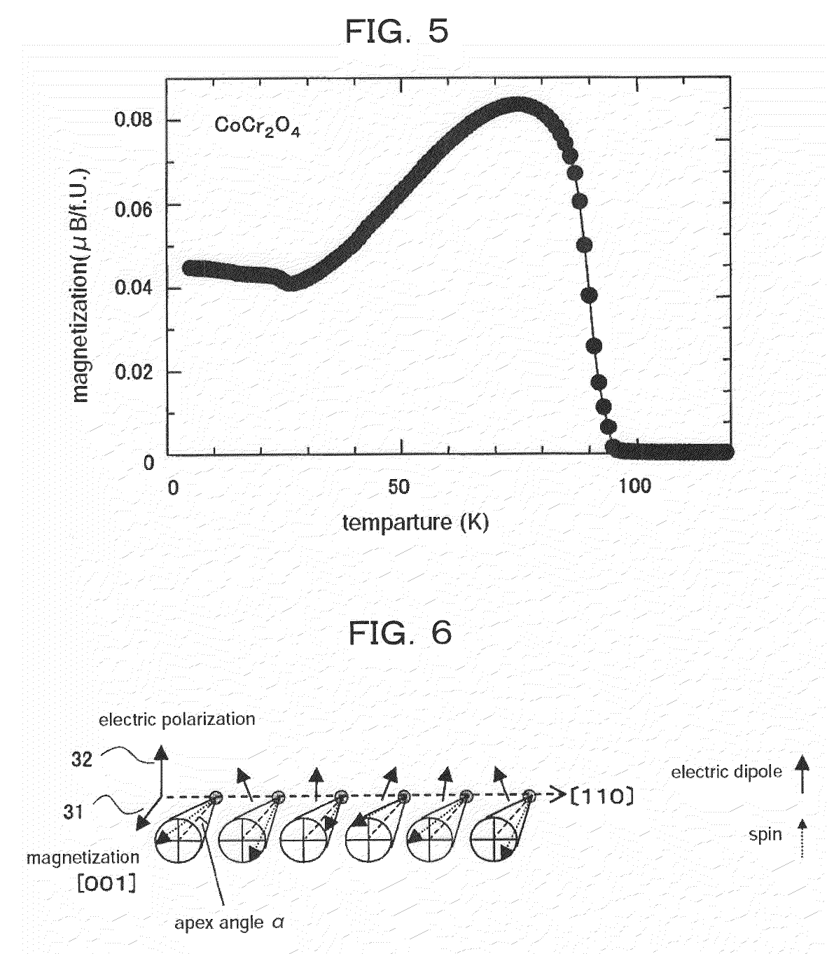

FIG. 5 is a diagram illustrating a temperature dependence of magnetization of a multiferroic solid state material CoCr₂O₄ according to the present invention.

When temperature is lowered from the room temperature, a transition to ferrimagnetism occurred at a temperature of 93K (Refer to Non Patent Document 2). At temperature 26K, it has a spin structure such that the orientation of the spin is rotating along an outer surface of a cone.

FIG. 6 is a diagram illustrating a spin structure of a multiferroic solid state material CoCr₂O₄ according to the present invention. The spin structure is that for a temperature of lower than 26K. The structure in which the orientation of the spin is rotating along an outer surface of a cone (apex angle α at the top of the cone is in a range of 0<α≦90 degrees) has an average magnetization in the direction [001]. Thus, while the front of each spin is rotating anti-clockwisely with [001] direction as a center axis, the arrangement of the spin progresses along a [110] direction.

When a solid state material has a spin structure such that the orientation of the spin is rotating along an outer surface of a cone (apex angle α at the top of the cone is in a range of 0<α≦90 degrees), an electric polarization generates. The orientation 32 of the generated electric polarization is in the direction of [−110] axis. In addition, 31 represents the orientation of magnetization.

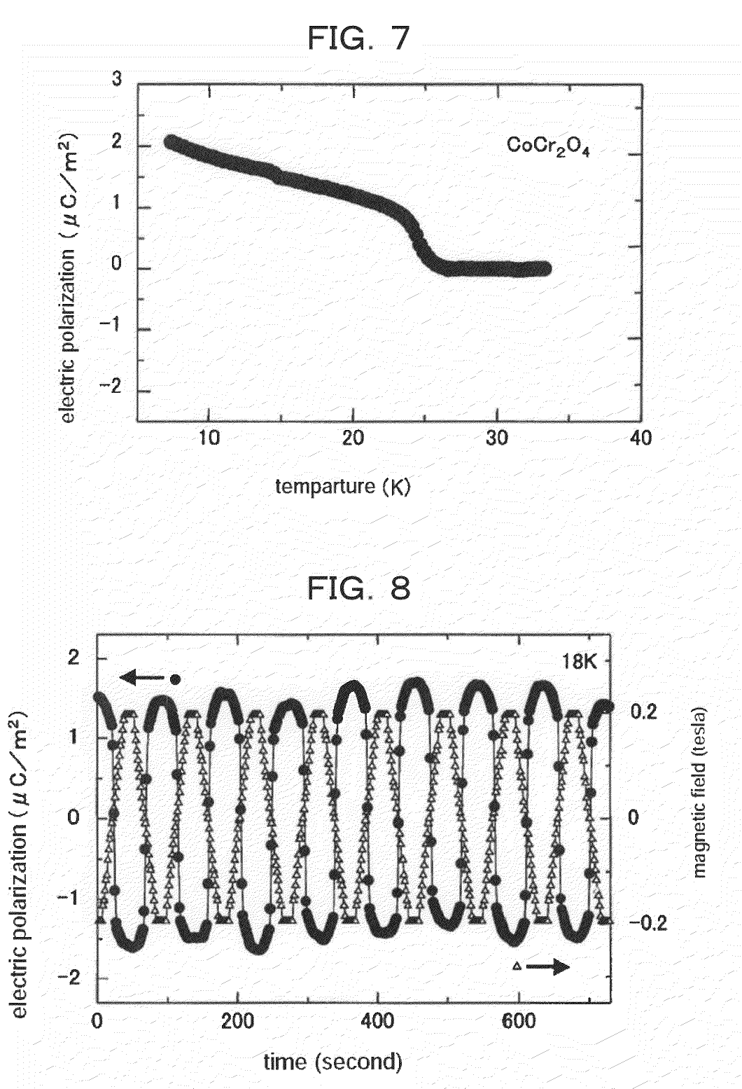

FIG. 7 is a diagram illustrating a temperature dependence of electric polarization of a multiferroic solid state material CoCr₂O₄ according to the present invention.

Referring to this Figure, it can be seen that an electric polarization generates at around a temperature of 26K or below. The electric polarization has an intensity of about 2 μC/m² at around 5K. In this case, the electric polarization generates in a direction perpendicular to the magnetization, as shown in FIG. 6.

It is understood that a material having a spin structure in which the orientation of the spin is rotating along an outer surface of a cone become a multiferroic material which has not only magnetization but also electric polarization at the same time.

FIG. 8 is a diagram illustrating a reversal of an electric polarization resulting from a reversal of an external magnetic field of a multiferroic solid state material CoCr₂O₄ according to the present invention.

As shown in FIG. 8, an orientation of a magnetic field (−0.2 T to +0.2 T) with frequency of about 0.01 Hz which is parallel to [001] direction is periodically reversed, the electric polarization is periodically reversed with the same frequency following the change of the magnetic field. This result demonstrates controllability of the orientation of the electric polarization of CoCr₂O₄ by the orientation of the external magnetic field.

It is thus demonstrated for the first time that for the multiferroic material having a spin structure in which the orientation of the spin is rotating along an outer surface of a cone (apex angle α at the top of the cone is in a range of 0<α≦90 degrees), the orientation of the electric polarization can be controlled by an external magnetic field.

The present embodiment is carried out in an ultra low temperature region, for example in a temperature region below 26K. The spin structure in which the orientation of the spin is rotating along an outer surface of a cone, however, has been found in many spinel solid state materials. If a multiferroic material with this structure is searched for, a material will be found which exhibits similar phenomenon at room temperature.

As shown in the embodiment demonstrating the controllability of an electric polarization by an magnetic field for the multiferroic solid state material CoCr₂O₄ which has not only ferromagnetism but also ferroelectricity at the same time, it is understood that the inverse process, i.e., control of an orientation of a magnetization by an electric field is also possible. In a ferroelectric material, an orientation of an electric polarization can be controlled by an electric field. It is automatically clear from the principle of reciprocity that the reversal of an electric polarization gives rise to the reversal of a magnetization simultaneously for the multiferroic material having a spin structure in which the orientation of the spin is rotating along an outer surface of a cone.

In the above description, explanation was given to the multiferroic solid state material CoCr₂O₄, however other chromium oxide such as MCr₂O₄ (M=Mn, Fe, Co, Ni) compound can be used similarly as a multiferroic solid state material.

The present invention is not limited to the embodiment described above, but various modifications can be made without departing from the scope of the invention, and these modifications shall not be excluded from the scope of the invention.

According to the present invention, the following advantages can be obtained.

(1) By applying an external magnetic applied to a multiferroic solid state material having both ferroelectricity and ferromagnetism which has a spin structure in which the orientation of spin is rotating along an outside surface of a cone (apex angle α at the top of the cone is in a range of 0<α≦90 degrees), an orientation of an electric polarization which is substantially perpendicular to said external magnetic field can be controlled.
(2) By applying an external electric field applied to a multiferroic solid state material having both ferroelectricity and ferromagnetism which has a spin structure in which the orientation of spin is rotating along an outside surface of a cone (apex angle α at the top of the cone is in a range of 0<α≦90 degrees), an orientation of an magnetization which is substantially perpendicular to said external electric field can be controlled.

These configurations enable to make a structure of, for example magnetic sensor element simple and realize a significant amount of cost reduction. Furthermore, the magnetic sensor element can be miniaturized, and becomes a magnetic sensor which can keep in step with the miniaturization of the magnetization region supporting information storage. On the other hand, a function to reverse a magnetization due to an electric field is suitable to a memory element. Unlike the conventional control of an orientation of a magnetization by a current induced magnetic field, the present control is based on an electric field induced effect so that current consumption can be suppressed significantly. It is thus possible to avoid a large power consumption, which is a drawback of the conventional MRAM element, and realize reduction in power consumption. Furthermore, a magnetization induced by an electric field has a hysteresis, which is suitable for non volatile memory element. A layer structure with small number of layers reduces a process cost significantly. The present invention provides a multiferroic non-volatile memory element (MFM element) with novelty, low power consumption, high density integration and low process cost.

### INDUSTRIAL APPLICABILITY

The multiferroic element in accordance with the present invention provides, for example a magnetic sensor element with a simple structure. The multiferroic element in accordance with the present invention provides a memory element with low cost.

1: A multiferroic element wherein by applying an external magnetic field to a multiferroic solid state material having both ferroelectricity and ferromagnetism which has a spin structure in which the orientation of spin is rotating along an outside surface of a cone (apex angle α at the top of the cone is in a range of 0<α≦90 degrees), an orientation of an electric polarization which is substantially perpendicular to said external magnetic field is controlled.

2: A multiferroic element wherein by applying an external electric field applied to a multiferroic solid state material having both ferroelectricity and ferromagnetism which has a spin structure in which the orientation of spin is rotating along an outside surface of a cone (apex angle α at the top of the cone is in a range of 0<α≦90 degrees), an orientation of an magnetization which is substantially perpendicular to said external electric field is controlled.

3: The multiferroic element according to claim 1, wherein the multiferroic solid state material comprising a chromium oxide including MCr₂O₄ (M=Mn, Fe, Co, Ni) compound.

4: The multiferroic element according to claim 2, wherein the multiferroic solid state material comprising a chromium oxide including MCr₂O₄ (M=Mn, Fe, Co, Ni) compound.

5: The multiferroic element according to claim 3, wherein the MCr₂O₄ (M=Mn, Fe, Co, Ni) compound is a single crystal produced under an environment of high gas pressure of a range from more than or equal to 2 atmosphere to less than 11 atmosphere by using the floating zone single crystal growth method.

6: The multiferroic element according to claim 4, wherein the MCr₂O₄ (M=Mn, Fe, Co, Ni) compound is a single crystal produced under an environment of high gas pressure of a range from more than or equal to 2 atmosphere to less than 11 atmosphere by using the floating zone single crystal growth method.
